(19) United States
(12) Patent Application Publication
(10) Pub. No.: US 2019/0152193 A1
(43) Pub. Date: May 23, 2019

(54) ISOLATION DEVICE AND METHOD

(71) Applicant: Leslie DAVIS, (US)

(72) Inventor: Leslie DAVIS, Darlington (AU)

(21) Appl. No.: 16/300,004

(22) PCT Filed: Feb. 17, 2017
(86) PCT No.: PCT/AU2017/050145

§ 371 Date: Nov. 8, 2018

(30) Foreign Application Priority Data
May 9, 2016 (AU) 2016901701

(51) Int. Cl. B32B 15/08; F16F 1/40; F16F 15/08; G10K 11/168; H04R 1/28; F16F 9/30

(52) U.S. Cl. CPC B32B 15/08; F16F 1/40; F16F 9/306; G10K 11/168; H04R 1/2892; F16F 15/08

(57) ABSTRACT

An isolation device (10) comprising a pad (10) having one or more layers of metallic foil (20) and one or more layers of polymer (30), the adjacent layers alternating between metallic foil (20) and polymer (30).

### RELATED APPLICATION

The present application is related to Australian Provisional Patent Application No. 2016901701 titled “Isolation device and method” and filed 9 May 2016 in the name of Leslie Davis, the entire content of which is incorporated by reference as if fully set forth herewith.

### TECHNICAL FIELD

The present disclosure relates to an isolation device and method. In particular, the present invention relates to an isolation device for use with audio and visual equipment. However, it will be appreciated by those skilled in the art that the invention may be applied to other technology areas.

### BACKGROUND OF THE INVENTION

Vibration plays a critical role on the operation of audio and visual equipment. For example, vibration is utilised within microphones to record sounds. Vibrations are also utilised by loudspeakers to reproduce sound. However undesirable vibrations can have significant adverse effects on the quality of sound generated by audio and visual equipment.

Audio and electronic equipment, such as amplifiers, turn tables, CD players, loudspeakers, may be very sensitive to vibrations. Vibrations are known to interfere with sound quality, and can also cause tracking errors, skipping or interference with other components. Equipment suffering from internal or external vibration may not perform as required, and may deliver sub-optimal sound qualities. Furthermore, a piece of vibrating equipment may cause adjacent or nearby equipment to perform in an unintended manner.

There are generally two distinct types of vibration which may have an effect on the performance of audio and visual equipment. That is, “structure borne” vibrations and “air borne” vibrations. Structure borne vibrations generally enter through a shelf or platform upon which the component rests. In contrast, air borne vibrations are the results of fluctuating air currents produced generally by the speakers, which may vibrate the enclosure or internal components of a component.

Normally, the most significant cause of vibration is the air borne vibrations, originating from the sound system itself, by way of the speakers, or other nearby speakers or related equipment. The louder the volume is operated at, the more the vibration will affect the equipment. Speakers create sound by vibrating the drivers at various frequencies. The low frequencies in particular may also vibrate the speaker box itself. Speaker boxes are often designed with rigid walls and internal cross-bracing to counteract the vibration. However, the forward and rearward motion of the woofer may cause the entire box to move in the opposing direction. This type of vibration is undesirable, and may cause problems with bass reproduction.

The second form of vibration results from external sources, such as air-conditioning systems, traffic and general ground vibrations (ambient vibrations).

Each speaker may be damped using spikes fitted to the base of the speaker box. Three or four spikes are typically used to suspend the speaker box above the floor or support surface. Spikes decrease the contact area with the support surface, allowing vibrations to travel away from the speaker box, while limiting the return path. However, this generally does not assist in isolating equipment such as amplifiers from vibrations, especially those structure borne vibrations discussed above.

Internal components such as capacitors and inductors can alter their values slightly, plus cause small microphonic effects, as a result of vibrations. This phenomenon is undesirable.

Equipment racking is one way of addressing structure borne vibrations. A well-designed rack will assist to isolate the equipment such as amplifiers from vibrations. Some racks use rubber mounts, others have point supports similar to speaker spikes. Sprung mechanisms are also sometimes used. Whilst racking provides a solution to counter the problems of vibrations, it is generally expensive and hence unsuitable for many small scale home applications.

Another option is to isolate each device individually, thereby attempting to decouple the component from the support surface. Rubber or polymer pads can be seated beneath the units in the rack or on another surface. The pads are intended to sit underneath the equipment, absorbing a portion of the vibrational energy. However, such dampening pads are known to be sub-optimal in the vibration absorbing properties. Some such pads are known to over dampen the vibrations, which is also undesirable.

### OBJECT OF THE INVENTION

It is an object of the present invention to substantially overcome or at least ameliorate one or more of the above disadvantages, or at least to provide a useful alternative.

### SUMMARY

In a first aspect, the present disclosure provides an isolation device comprising:

a pad having one or more layers of metallic foil and one or more layers of polymer, the adjacent layers being alternated between metallic foil and polymer.

The metallic foil is preferably an aluminium foil.

The aluminium foil is preferably a fibre reinforced tape.

The isolation device preferably includes three layers of metallic foil and four layers of polymer.

The isolation device preferably includes five layers of metallic foil and six layers of polymer.

The isolation device preferably includes six layers of metallic foil and seven layers of polymer.

The isolation device preferably includes seven layers of metallic foil and eight layers of polymer.

The polymer is preferably an adhesive laminating film.

The pad is preferably circular.

The pad preferably has a diameter of between about 50 mm and 54 mm.

The pad preferably has a diameter of about 52 mm.

The fibre is preferably arranged in a matrix of individual strands.

In a second aspect, the present disclosure provides an isolation device comprising:

a pad having one or more layers of metallic foil and one or more layers of polymer, the adjacent layers being alternated between metallic foil and polymer, said pad being suitable for placement in a loudspeaker enclosure.

The metallic foil is preferably an aluminium foil.

The aluminium foil is preferably a fibre reinforced tape.

The isolation device preferably includes three layers of metallic foil and four layers of polymer.

The isolation device preferably includes five layers of metallic foil and six layers of polymer.

The isolation device preferably includes six layers of metallic foil and seven layers of polymer.

The isolation device preferably includes seven layers of metallic foil and eight layers of polymer.

The polymer is preferably an adhesive laminating film.

The pad is preferably rectangular in shape.

The fibre is preferably arranged in a matrix of individual strands.

In one arrangement, the pad is adapted to be placed adjacent to one or more inner surfaces of a loudspeaker enclosure. In one implementation, the pad is affixed to said one or more inner surfaces using an adhesive.

In one arrangement, the pad is adapted to be used in association with an electronic component associated with said loudspeaker enclosure.

In one arrangement, the pad is adapted to be used in association with a crossover circuit associated with said loudspeaker enclosure.

In a third aspect, the present disclosure provides a method of acoustically treating an audio system having an electronic component, the method comprising the step of:

placing a pad between an underside of said electronic component and a supporting surface on which the electronic component is to be placed, each said pad having one or more layers of metallic foil and one or more layers of polymer, the adjacent layers being alternated between metallic foil and polymer.

In one arrangement, the underside of said electronic component includes at least one foot by which the electronic component is supported.

In one arrangement, the electronic component is one of an amplifier, tuner, turntable, compact disc (CD) player, Digital Versatile Disc (DVD) player, Blu-Ray player, network streaming device, pre-amplifier, receiver, laptop, and network attached storage (NAS) device.

In a fourth aspect, the present disclosure provides a method of dampening a loudspeaker driver, the method comprising the steps of:

placing a pad around a circumference of an aperture located in a front surface of a loudspeaker enclosure, said aperture configured to receive said loudspeaker driver, wherein placement of said pad results in said pad being positioned between said front surface of said loudspeaker and a rear surface of said loudspeaker driver when coupled to said loudspeaker enclosure, each said pad having one or more layers of metallic foil and one or more layers of polymer, the adjacent layers being alternated between metallic foil and polymer.

In a fifth aspect, the present disclosure provides a method of dampening an electronic component, the method comprising the step of:

placing a pad between said electronic component and a substrate, said pad having one or more layers of metallic foil and one or more layers of polymer, the adjacent layers being alternated between metallic foil and polymer.

In one arrangement, the electronic component is one of a capacitor, transformer, coil winding, resistor, transistor, and microchip.

In one arrangement, the substrate is a glass-reinforced epoxy laminate sheet.

### BRIEF DESCRIPTION OF THE DRAWING

One or more preferred embodiments of the invention will now be described by way of specific example with reference to the accompanying drawings, in which:

FIG. 1 is a perspective view depicting an isolation device according to the present invention;

FIG. 2 is a schematic representation of a hi-fi amplifier having a plurality of feet supported by a plurality of isolation devices;

FIG. 3 is a schematic block diagram representation of a crossover circuit utilising isolation devices;

FIG. 4 is a schematic block diagram representation of the crossover circuit of FIG. 3 affixed to an inner surface of a vertical wall of a loudspeaker enclosure;

FIG. 5 shows a front surface of a loudspeaker enclosure having an aperture for accommodating a loudspeaker driver, with isolation devices positioned about a circumference of the aperture;

FIG. 6 is a schematic block diagram representation of a system used to test frequency response of a loudspeaker enclosure;

FIG. 7 is a graph of frequency response recorded by a frequency spectrum analyser from a front panel of a loudspeaker enclosure;

FIG. 8 is a graph of a frequency response recorded by a frequency spectrum analyser from a side panel of a loudspeaker enclosure;

FIG. 9 is a graph of a frequency response recorded by a frequency spectrum analyser from a tweeter surround of the loudspeaker enclosure; and

FIG. 10 is a graph of the frequency response from a woofer dustcap of a loudspeaker.

### DETAILED DESCRIPTION OF THE PREFERRED EMBODIMENTS

There is disclosed herein an isolation device 10. In particular, the isolation device 10 is intended for vibration isolation for improving the performance of audio and visual electronic equipment. However, it will be appreciated by those skilled in the art that the isolation device 10 can be utilised with other electronic equipment or in other environments which may be sensitive to vibrations.

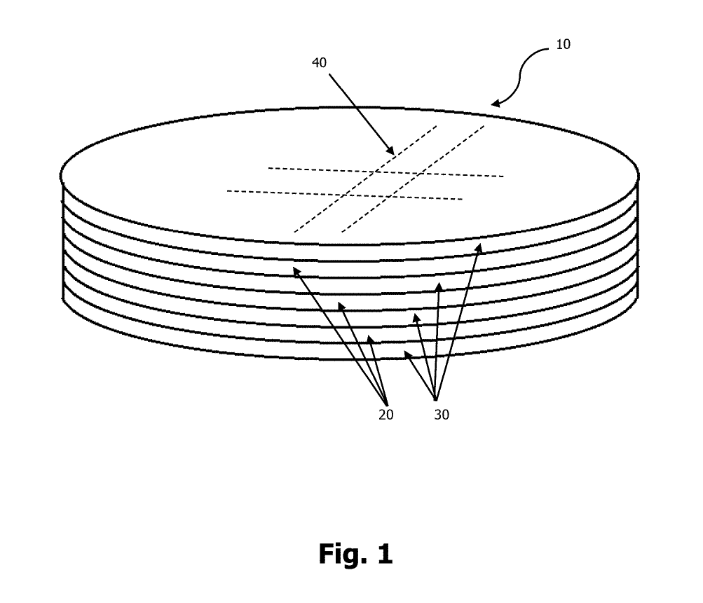

Referring to FIG. 1, the device 10 is in the form of a generally circular shaped disc or pad 10. The pad 10 has a diameter of between about 50 and 54 mm. In the preferred embodiment, the pad 10 is approximately 52 mm in diameter. However, it will be appreciated by those skilled in the art that the pad 10 may be provided in other embodiments that may be larger or smaller in diameter. In one embodiment not shown in the drawings, the pad 10 may be provided in the form of a rectangle, square, triangle, polygon, or other shape.

The pad 10 is defined by a plurality of layers of metallic foil 20. Each layer of foil 20 is separated by a layer of polymer 30. In a preferred embodiment, each layer of foil 20 is aluminium foil 20. In this embodiment, each layer of foil 20 is preferably fabricated from a fibre reinforced aluminium backing tape, such as the 620 “Aluminium Foil Tape” sold by HUSKYTAPE™. This tape is fibre 40 reinforced and includes a grid or matrix type fibre arrangement, wherein each strand of the fibre 40 is spaced from the adjacent and generally parallel fibre 40 strands by approximately 5 mm to 6 mm.

In a preferred embodiment, the polymer layers 30 are each provided by a laminating film, such as the DOL 2000 Series polymeric plasticised calendered laminating film sold by Avery Dennison™.

In the preferred embodiment, the isolation device 10 is manufactured with the following specification:

| | |
|---|---|
| First layer | Polymer 30 |
| Second layer | Aluminium 20 |
| Third layer | Polymer 30 |
| Forth layer | Aluminium 20 |
| Fifth layer | Polymer 30 |
| Sixth layer | Aluminium 20 |
| Seventh layer | Polymer 30 |

However, it will be appreciated by those skilled in the art that there may be more than seven layers provided by adding additional alternating layers of the aluminium foil 20 and the polymer 30. For example, in one embodiment, there are 6 layers of aluminium foil 20 and 7 layers of polymer 30.

Alternatively, there may be fewer than seven layers in total. For example, 5 or 3 layers in total.

On account of the alternating layers of the aluminium foil 20 and the polymer 30, the isolation device 10 operates based on constrained layer damping, whereby a viscoelastic material is sandwiched between two layers of a stiffer material, in this case the aluminium foil 20. Mechanical energy in the form of vibrations is trapped between the adjacent layers of aluminium foil 20 and dissipated in the constrained layers of polymer 30 as heat.

In use, the pads 10 are located beneath various components of an audio or visual system. For example, three or four pads 10 may be positioned beneath an amplifier, such that pads 10 are sandwiched between the amplifier and the support rack or shelf.

Advantageously, the isolation device 10 provides accurate stereo imaging.

Furthermore, the isolation device 10 provides cleaner and detailed bass reproduction.

A further advantage is that the device 10 provides detailed imaging of instrumentation.

Advantageously, the device 10 provides a suitable level of vibration damping without overdamping.

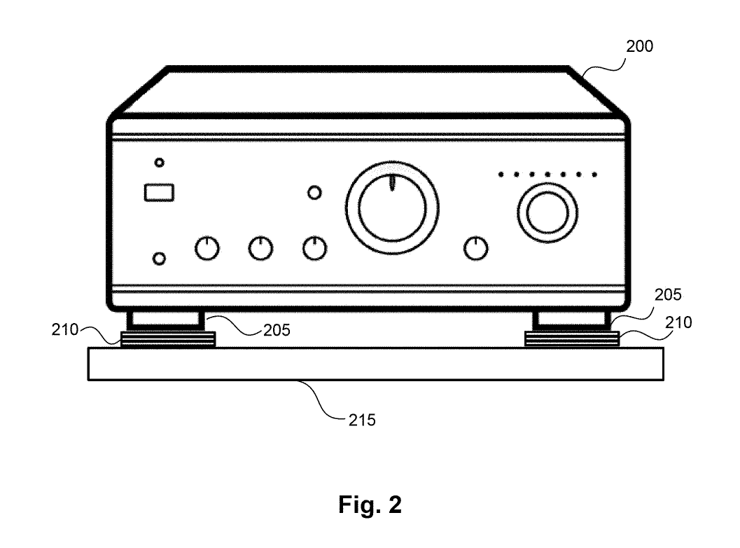

FIG. 2 is a schematic representation of a hi-fi amplifier 200 having a plurality of feet 205. In the example of FIG. 2 a plurality of isolation devices 210 in accordance with the present disclosure are placed between the feet 205 of the amplifier 200 and a surface 215 on which the amplifier is to be placed. The surface 215 may be, for example, a shelf, table top, plinth, or the like. In use, the isolation devices 210 help to absorb, dissipate, or otherwise ameliorate vibrations produced by the amplifier 200.

While the example of FIG. 2 shows an amplifier, it will be appreciated that any other electronic equipment may be used, including, for example, but not limited to, turntables, compact disc (CD) players, Digital Versatile Disc (DVD) players, Blu-Ray players, network streaming devices, pre-amplifiers, receivers, laptops, network attached storage (NAS) devices, and the like. Further, in cases in which the electronic equipment does not have dedicated feet or spikes on which to stand, one or more isolation devices 210 may be placed between a lower surface of the electronic equipment and the surface 215 on which the electronic equipment is to be placed.

The isolation device of the present disclosure may also be suitable for placement inside electronic and audio component devices. Such electronic and audio component devices may include, for example, amplifiers, tuners, turntables, compact disc (CD) players, Digital Versatile Disc (DVD) players, Blu-Ray players, loudspeakers, network streaming devices, pre-amplifiers, receivers, laptops, and network attached storage (NAS) devices. In such implementations, the isolation device may be placed, for example, along one or more inner surfaces of the relevant device. The isolation device may also be used in the manufacture of electronic component devices, such as capacitors, inductors, transformers, resistors, and the like, wherein the isolation device may be used internally in such devices or as an external pad to which such component devices are affixed.

In one arrangement, the isolation device is suitable for placement within a loudspeaker enclosure. In such an arrangement, the isolation device may be presented as a sheet of alternating layers, in a manner consistent with that described above in relation to the isolation device 10 of FIG. 1. One or more such sheets may be rectangular in shape. Alternatively, the sheets may be any other shape, including irregular shapes to fit an interior shape of an electronic or audio component device.

In one arrangement, the isolation device 10 is presented as a pad in the form of a sheet or strips that that adapted to be affixed to one or more inner surfaces of a loudspeaker enclosure. In one implementation, the pad is affixed to said one or more inner surfaces using an adhesive or other fixing means. Such application of the isolation device within a loudspeaker enclosure acts to mitigate unwanted vibrations within such a loudspeaker enclosure.

In an alternative arrangement, the isolation device is applied to individual electronic components, such as capacitors, or a grouping of such electronic components, such as a crossover circuit associated with a loudspeaker. For example, a crossover circuit may include a set of individual electronic components positioned on a substrate, with electrical connections among the various electronic components. One or more isolation devices in accordance with the present disclosure are presented in the form of small sheets or strips that are placed between one or more electronic components and the substrate. The electronic components are glued to the substrate, either directly or with an intervening isolation device between the component and the substrate. In such a configuration, the isolation device mitigates vibrations from the electronic components.

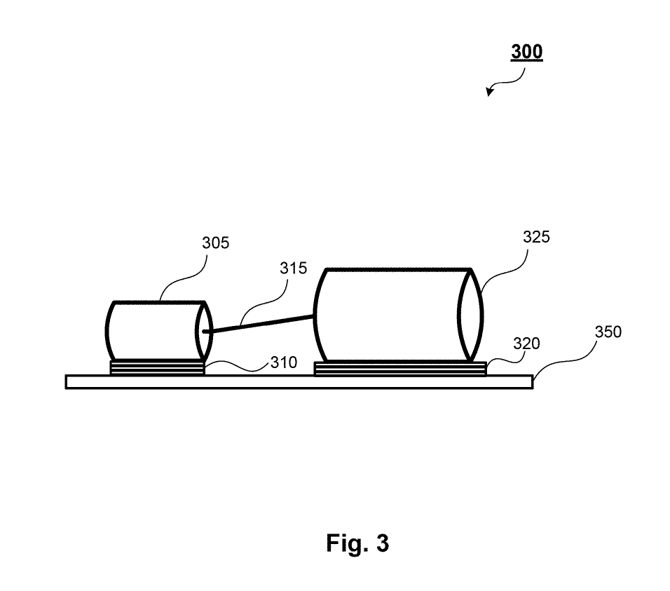

FIG. 3 is a schematic block diagram representation of a crossover circuit 300 utilising isolation devices 310, 320. A first isolation device 310 is placed between a first electronic component 305 and a substrate 350. The substrate 350 may be, for example, a printed circuit board, such as a glass-reinforced epoxy laminate sheet. The substrate 350 may also be any other suitable material, preferably having low electrical conductivity. In the example of FIG. 3, the first electronic component 305 is glued to the first isolation device 310, which is in turn glued to an upper surface of the substrate 350. A second electronic component 325 is glued to a second isolation device 320, which is in turn glued to an upper surface of the substrate 350.

The first and second electronic components 305, 325 may be any discrete electronic component, including, but not limited to, capacitors, transformers, coils, resistors, transistors, microchips, inductors, and the like. The laminated structure of the isolation devices 310, 320 absorbs, dissipates, or otherwise mitigates vibrations between the electronic components 305, 325 and the substrate 350.

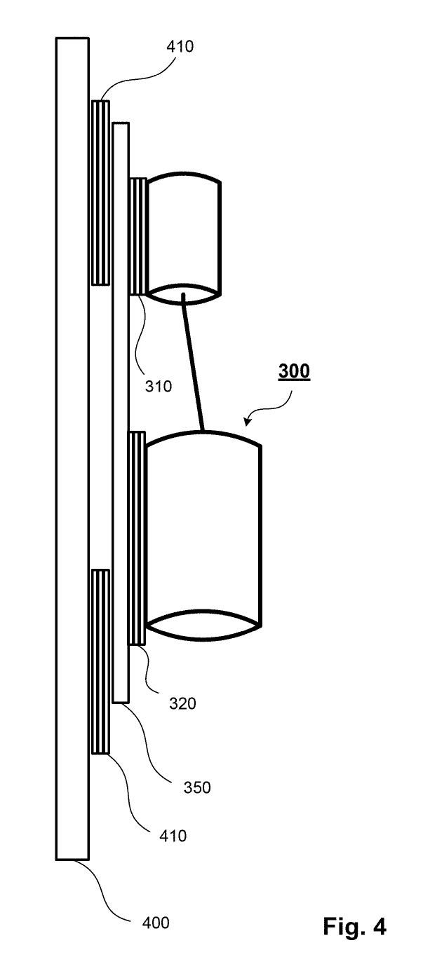

In a further arrangement, one or more isolation devices are positioned between the substrate of the crossover circuit and a loudspeaker enclosure to which the crossover device is attached. FIG. 4 is a schematic block diagram representation of the crossover circuit 300 affixed to an inner surface of a vertical wall 400 of a loudspeaker enclosure. For the sake of clarity, the rest of the loudspeaker enclosure is not shown. A plurality of isolation devices 401 are positioned between the substrate 350 of the crossover circuit 300 and the inner surface of the vertical wall 400. In one embodiment, a plurality of screws are used to secure the substrate 350 to the inner surface of the vertical wall 400. The screws may pass through the isolation devices 410 or may be otherwise positioned to secure the crossover circuit 300 to the vertical wall 400. In an alternative embodiment, the substrate 350 is glued to the isolation devices 410, which in turn are glued or otherwise affixed to the inner surface of the vertical wall 400. The isolation devices 410 reduce the transfer of vibrations between the crossover circuit 300 and the vertical wall 400 of the loudspeaker enclosure.

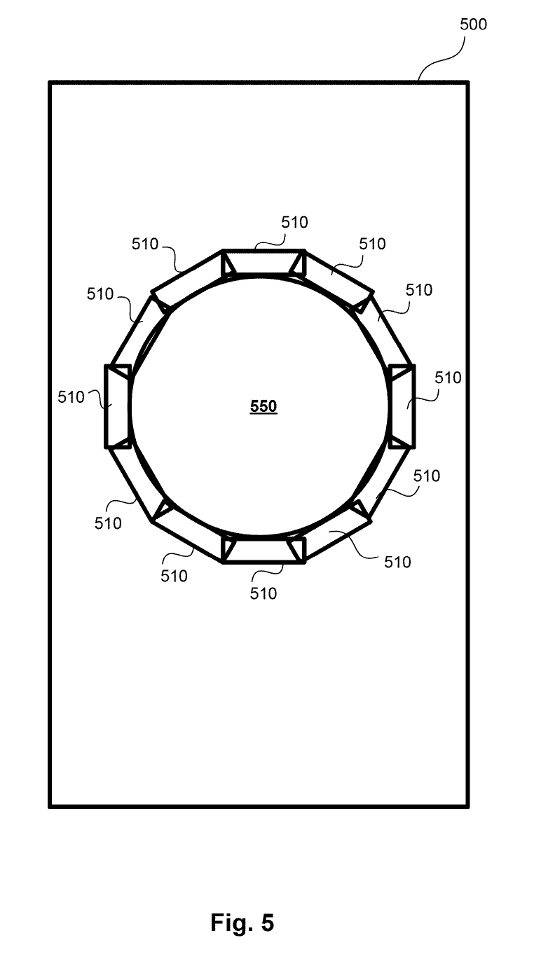

In a further arrangement, the isolation device is configured in a shape suitable to be used as a washer between a loudspeaker driver and a loudspeaker enclosure. In such an arrangement, one or more elongated isolation devices are presented as strips attached between the loudspeaker driver and the loudspeaker enclosure. In an alternative arrangement, an isolation device is presented as a sheet from which a customised shape is cut to act as the washer. FIG. 5 shows a front surface of a loudspeaker enclosure 500 having an aperture 550 for accommodating a loudspeaker driver (not shown). A plurality of isolation device strips 510 are positioned around the circumference of the aperture 550, so as to act as a washer between the loudspeaker enclosure 500 and the loudspeaker driver, when secured to the loudspeaker enclosure 500. The isolation device strips 510 mitigate vibration caused by the travel of the loudspeaker cone when in use.

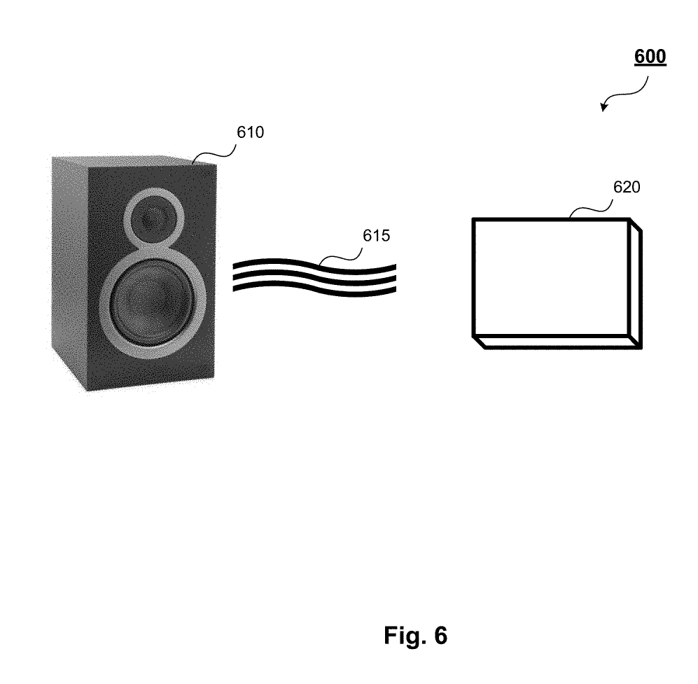

FIG. 6 is a schematic block diagram representation of a system 600 used to test a loudspeaker enclosure 610 in which a crossover circuit is positioned, the crossover circuit having one or more electronic components attached to a substrate of the crossover circuit via one or more isolation devices, in a manner similar to that depicted in FIG. 3. Further, the crossover circuit is affixed to an inner surface of the loudspeaker enclosure 610 via one or more isolation devices, in a manner similar to that depicted in FIG. 4.

The system 600 includes the loudspeaker enclosure 610 and a frequency spectrum analyser 620 for recording transmissions 615 from the loudspeaker enclosure 610. The system 600 was adjusted during testing, so that the frequency spectrum analyser 620 recorded signals output from different regions of the loudspeaker enclosure 610. Tests were conducted on a loudspeaker enclosure 600 without any treatment using isolation devices and a loudspeaker enclosure 600 with treatment using isolation devices, as described above.

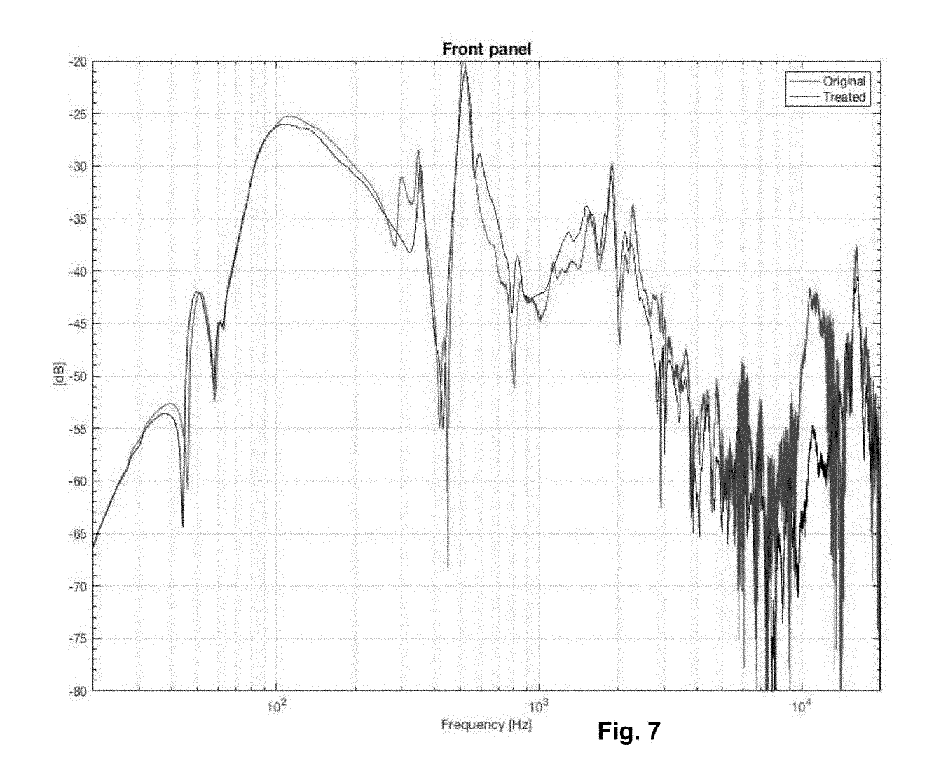

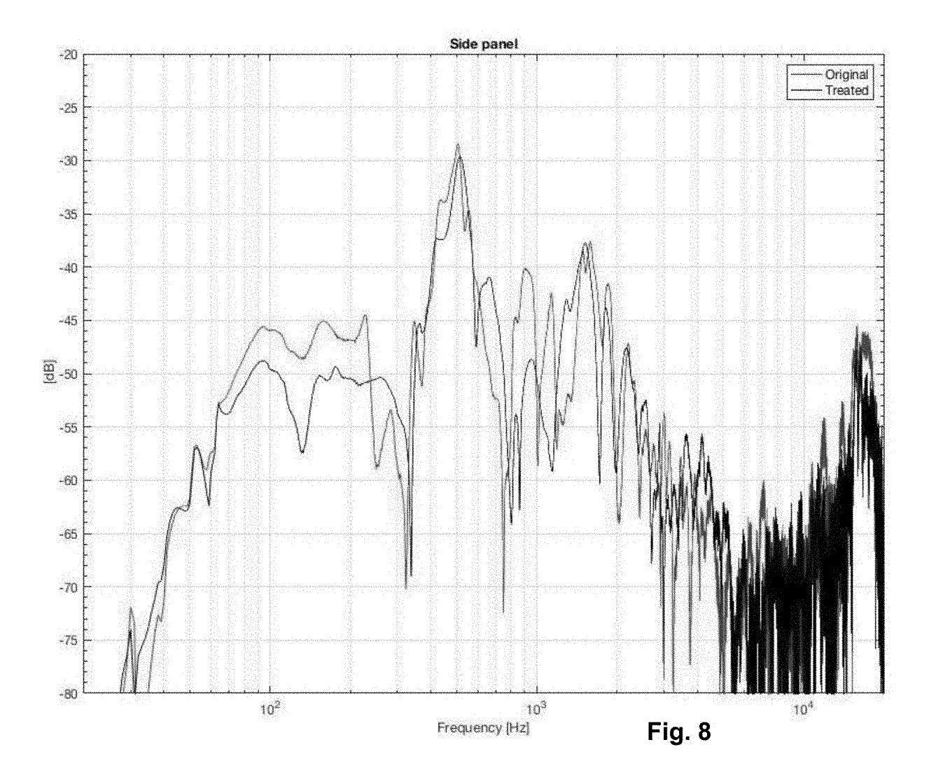

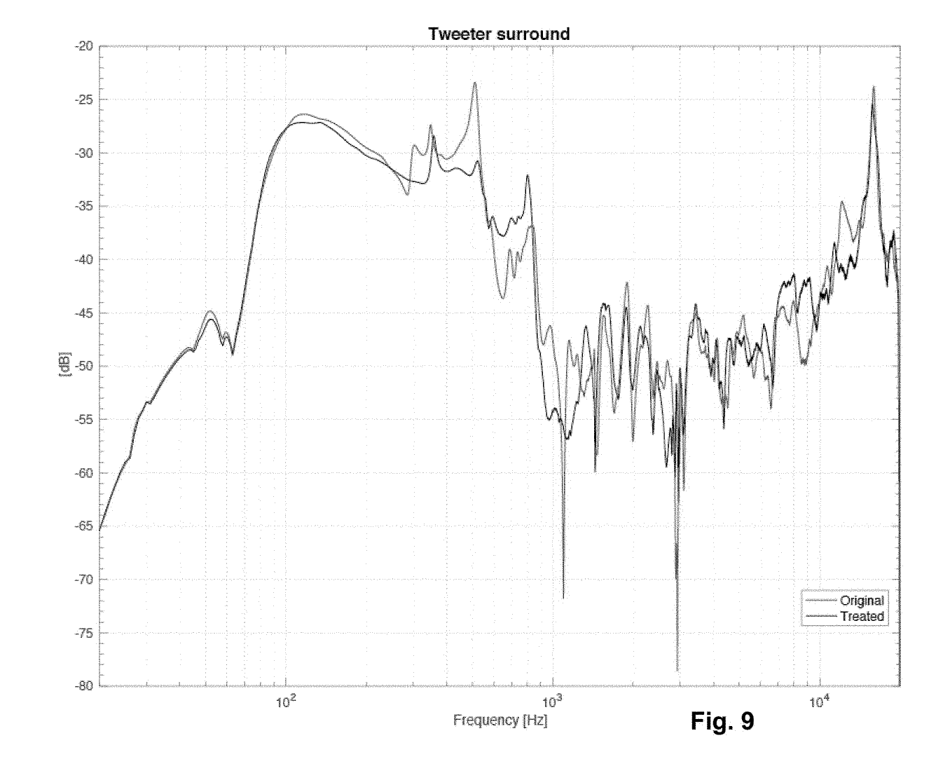

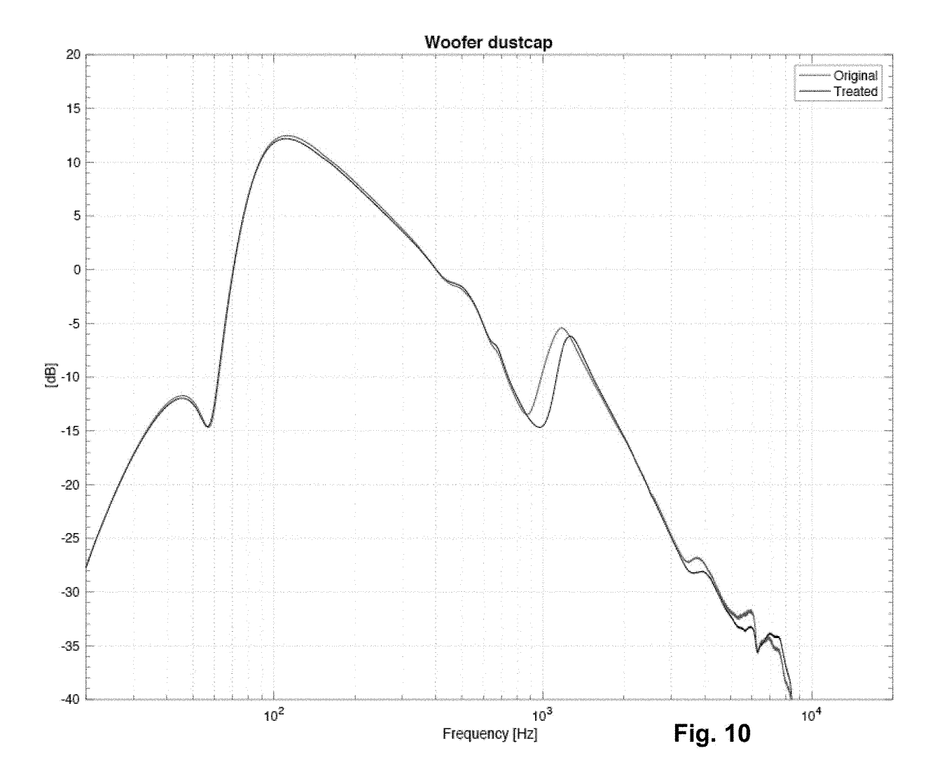

FIG. 7 is a graph of the frequency response recorded by the frequency spectrum analyser 620 from a front panel of the loudspeaker enclosure 610. FIG. 8 is a graph of the frequency response recorded by the frequency spectrum analyser 620 from a side panel of the loudspeaker enclosure 610. FIG. 9 is a graph of the frequency response recorded by the frequency spectrum analyser 620 from a tweeter surround of the loudspeaker enclosure 610. FIG. 10 is a graph of the frequency response recorded by the frequency spectrum analyser 620 from a woofer dustcap of the loudspeaker enclosure 610.

Each of the frequency response graphs of FIGS. 7 to 10 compare the treated and untreated loudspeaker enclosure. It is evident from the deviation between the respective frequency response traces that the isolation devices present within the loudspeaker enclosure have an effect. The effect is audible, resulting is a reduction in the noise floor and cleaner sound.

Although the invention has been described with reference to specific examples, it will be appreciated by those skilled in the art that the invention may be embodied in many other forms.

1. An isolation device comprising:
a pad having one or more layers of metallic foil and one or more layers of polymer, the adjacent layers being alternated between metallic foil and polymer.

2. The isolation device of claim 1, wherein the metallic foil is an aluminum foil.

3. The isolation device of claim 2, wherein the aluminum foil is a fibre reinforced tape.

4. The isolation device of claim 1, wherein there are three layers of metallic foil and four layers of polymer.

5. The isolation device of claim 1, wherein there are five layers of metallic foil and six layers of polymer.

6. The isolation device of claim 1, wherein there are six layers of metallic foil and seven layers of polymer.

7. The isolation device of claim 1, wherein there are seven layers of metallic foil and eight layers of polymer.

8. The isolation device of claim 1, wherein the polymer is an adhesive laminating film.

9. The isolation device of claim 1, wherein the pad is circular.

10. The isolation device of claim 7, wherein the pad has a diameter of between about 50 mm and 54 mm.

11. The isolation device of claim 8, wherein the pad has a diameter of about 52 mm.

12. The isolation device of claim 3, wherein the fibre is arranged in a matrix of individual strands.

13. An isolation device comprising:
a pad having one or more layers of metallic foil and one or more layers of polymer, the adjacent layers being alternated between metallic foil and polymer, said pad being presented in the form of a sheet suitable for being affixed to an inner surface of a loudspeaker enclosure.

14. The isolation device according to claim 13, wherein said sheet is configured for placement between a substrate of a crossover circuit and said inner surface of said loudspeaker enclosure.

15. A method of acoustically treating an audio system having an electronic component, the method comprising the step of:
placing a pad between an underside of said electronic component and a supporting surface on which the electronic component is to be placed, each said pad having one or more layers of metallic foil and one or more layers of polymer, the adjacent layers being alternated between metallic foil and polymer.

16. The method according to claim 15, wherein the underside of said electronic component includes at least one foot by which the electronic component is supported.

17. The method according to claim 15, wherein said electronic component is selected from the group consisting of an amplifier, tuner, turntable, compact disc (CD) player, Digital Versatile Disc (DVD) player, Blu-Ray player, network streaming device, pre-amplifier, receiver, laptop, and network attached storage (NAS) device.

18. A method of dampening a loudspeaker driver, the method comprising the steps of:
placing a pad around a circumference of an aperture located in a front surface of a loudspeaker enclosure, said aperture configured to receive said loudspeaker driver, wherein placement of said pad results in said pad being positioned between said front surface of said loudspeaker and a rear surface of said loudspeaker driver when coupled to said loudspeaker enclosure, each said pad having one or more layers of metallic foil and one or more layers of polymer, the adjacent layers being alternated between metallic foil and polymer.

19. A method of dampening an electronic component, the method comprising the step of:
placing a pad between said electronic component and a substrate, said pad having one or more layers of metallic foil and one or more layers of polymer, the adjacent layers being alternated between metallic foil and polymer.

20. The method of claim 19,
wherein said electronic component is one of a capacitor, transformer, coil winding, resistor, transistor, and microchip, and
further wherein said substrate is a glass-reinforced epoxy laminate sheet.
